(19) United States
(12) Patent Application Publication
(10) Pub. No.: US 2005/0125347 A1
(43) Pub. Date: Jun. 9, 2005

(54) Bill payment authorization system and method

(76) Inventors: Ronald P. Akialis JR., Buffalo Grove, IL (US); John C. LaBue, Wheaton, IL (US)

Correspondence Address: KRAMER LEVIN NAFTALIS & FRANKEL LLP;INTELLECTUAL PROPERTY DEPARTMENT, 919 THIRD AVENUE, NEW YORK, NY, 10022, US

(21) Appl. No.: 10/730,228

(22) Filed: Dec. 8, 2003

(51) Int. Cl. G06F 17/60

(52) U.S. Cl. 705/40

(57) ABSTRACT

Authorization for credit card or bank account charges are provided for a billing party in response to electronic payment requests sent over the Internet from customers. Web services software is used to facilitate the transmission of authorization information to each biller's website where it can be-formatted to the biller's specification. Notification of the authorization or rejection of the payment request is sent to the consumer by the biller, and also by the authorizing party directly by e-mail. Individual transaction identification numbers and billing personnel identification numbers can be provided to the billing party by the authorizing party. Credit/debit card confirmation numbers can be used to minimize fraud.

This invention relates to systems and methods for authorizing the payment of bills, and particularly relates to such systems and methods using web services technology.

For many organizations faced with the chore of obtaining payments for bills they submit for goods or services, the task of obtaining authorization for electronic payments charged to credit or debit cards or bank accounts is onerous and/or relatively costly. As a result, they often employ outside firms to obtain the authorization.

In a typical prior system and method used by such outside firms, the bill payer or “consumer” sent an electronic payment request from its computer through the worldwide web (the “Internet”). The payer sent information including identification of the bill being paid and the debit or credit card or the bank account to which the payment is to be charged. This information was used by the outside firm (the authorizing party) which then obtained authorization from the credit or debit card company or bank, or a rejection of such authorization, and sent a corresponding message to the payer and to the biller's website.

A problem with such prior systems was that the biller often was not satisfied because it was apparent to the consumer that the authorization was not obtained by the biller, and had the potential for customer displeasure.

In later systems, the foregoing problem was alleviated by the use of “web services” software, such as that using “SOAP” (“Simple Object Access Protocol”). A tool kit has been developed by Microsoft facilitating the use of the SOAP protocol. This protocol allows the authorization information to be transmitted to the biller's website from which it can be sent to the customer in the biller's format—as if the authorization had been obtained by the biller.

Despite the success in using “web services” technology, other problems remain in the provision of payment authorization information. It is an object of the present invention to solve or alleviate those problems.

One such problem has been that the authorization information received by the consumer from the biller often was not in a form suitable for making a printed record of the authorization. Also, the notice sometimes was not received by the customer.

In accordance with the present invention, Applicants have alleviated the problem by providing an e-mail notice to the consumer at or near the time when notice is sent to the billing party's website. This has the double benefit of giving the consumer an easily printed record of the approval, as well as greater assurance of notification. Also, it avoids any significant increase of traffic through the authorizing party's website.

Preferably, the authorization message is in text form, in a format specified by the billing party so that it is not apparent to the consumer that the message is coming from anyone other than the billing party. Alternatively, the message is sent in HTML format to provide enhanced graphic and display capabilities.

Another problem is that of credit or debit card fraud. For example, people who learn the account number of a credit card sometimes use it to make unauthorized charges to the card.

Most cards today have, in addition to the account number on the front of the card, a verification code which appears only on the reverse side of the card. Applicants have made use of this additional information by optionally requiring the verification code to be submitted at the time of the payment, thus substantially increasing the likelihood that the payer actually has the credit card in his or her possession when charging the payment. The authorizing party has the credit/debit card company check the confirmation number against the other card information received to make certain that they correctly match with the company records, and the authorizing party then makes an authorization decision and communicates it to the biller and the consumer. This helps reduce credit/debit card fraud.

Another problem is that some billers cannot uniquely identify each bill payment transaction on its own. Thus, such parties have difficulty in tracking payment transactions in order to resolve uncertainties or disputes over payment.

In accordance with the present invention, this problem is solved by assigning a transaction number to each transaction for a given billing party and reporting the numbers to the billing party so as to provide a mechanism for facilitating the tracing of payment transactions.

A further problem is that some billing parties compensate their collection employees by paying them bonuses based on the amount of the payments successfully obtained by that employee. However, records of such amounts are not available.

In accordance with another feature of the invention, the foregoing problem is addressed by the authorizing party recording the identification of the billing employee responsible for each payment transaction which is approved, and then reporting that identification to the biller to enable the billing employee to obtain proper credit for obtaining the payment.

Additional problems include those of making the system even more fraud-resistant, flexible and cost effective; obtaining credit card verification before the payment transaction is completed; reversing a payment after it has been made; updating billing information for consumers to reduce payment errors; restricting charges to certain accounts as a fraud deterrent; pre-determination of service charge fees; and the burden associated with the usual batch transfer of payment requests and other file transfers.

The foregoing and other objects and advantages of the invention will be apparent from or set forth in the following description and drawings.

### IN THE DRAWINGS

FIG. 1 is a block diagram of a system used to provide payment authorization information in accordance with the present invention; and

FIG. 2 is a flow chart illustrating the payment authorization method of the invention.

### PAYMENT AUTHORIZATION SYSTEM

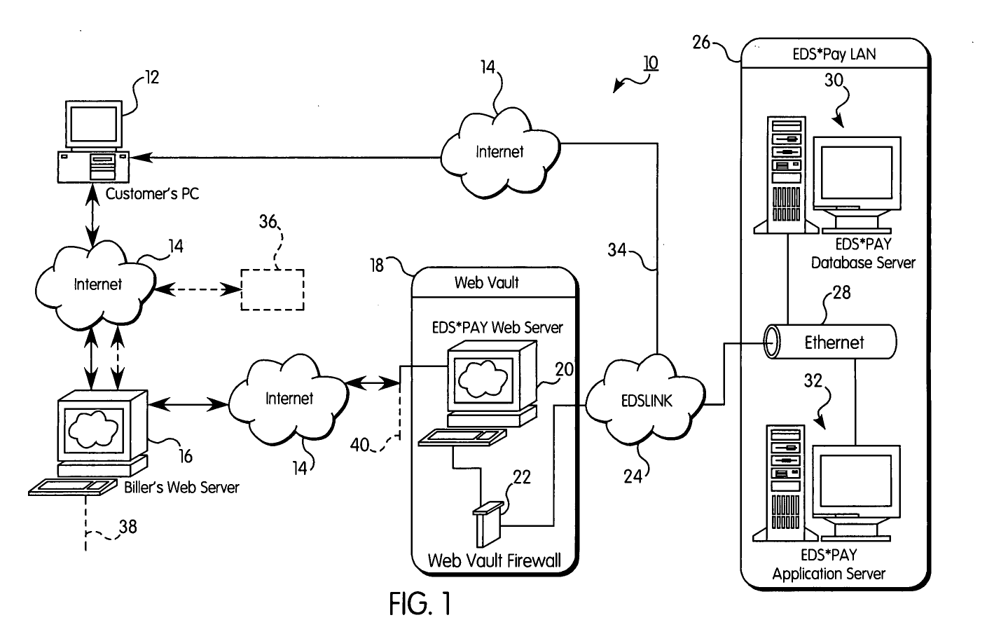

FIG. 1 is a schematic diagram illustrating a preferred embodiment of the payment authorization system 10 of the invention.

The system 10 includes a customer's personal computer 12. It should be understood that this is merely one example of a large number of computers of customers which might be used to initiate payment of bills. Other such customer computers are indicated schematically at 36.

Each customer PC is connected through the worldwide web or “Internet” 14 to a biller's web server 16 when the customer initiates activity to make a payment to the biller.

It should be understood that, in a typical system there are many other web servers for other billers that use the bill payment authorization services of the invention. Such additional web servers are indicated schematically by the dashed line 38 in FIG. 1.

It also should be understood that there may be a plurality of web servers for any given billing party.

During a payment authorization transaction, each billing party's web server communicates, through the worldwide web, at 14, to the authorizing party's web vault 18. The web vault 18 includes at least one web server 20 and a fire wall 22 which prevents unauthorized access from the Internet to the private networks used in the remainder of the authorization system.

The web server 20 communicates through the fire wall to a private network or link 24 to a local area network (“LAN”) 26. The LAN 26 includes a data base server 30 and an application server 32 interconnected by an Ethernet link 28 and protocol with one another and through the link 24 to the web vault. The data base server 30 stores and retrieves information forming the data base for the system, whereas the application server stores the application program and operates the system to perform the pay authorization functions.

Preferably, the web server 20 in the web vault stores and uses web services software such as the Microsoft SOAP tool kit to provide the SOAP protocol for transmission of information between the web server 20 and the billers' web servers. The Microsoft tool kit, which is used with Microsoft languages, can be readily downloaded from the Internet. Other tool kits which are similarly available for use with other languages include Apache SOAP (Java); SOAP::Lite (Perl); and OpenSoap(C).

Each of the biller's web servers should be programmed so as to enable communications according to the protocol selected and used at the web vault server 20. For example, if SOAP (Microsoft) is the protocol selected, each web server can be programmed using the same tool kit as that used to program the web server 20. By this means, the information communicated from the web server 20 to the biller's web server can be customized to the format desired by the biller so that the biller can transmit the information to the payer's computer in a format with which the payer is familiar and may have come to associate with the billing party.

The communication between the web vault and various different biller's web servers is indicated schematically by the dashed line 40 in FIG. 1. Each such communication is, of course, through the Internet.

If desired, the web vault 18 and the LAN 26 can be located physically near one another. However, it often is advantageous to locate the web vault at a central web server location, together with a relatively large group of other web servers, so that all of the web servers can be serviced and maintained efficiently and economically by a staff trained for the purpose. Then, the LAN 26 can be located elsewhere, perhaps many miles away, at a location convenient for headquartering the business, programming and LAN maintenance operations.

Line 34 in FIG. 1 illustrates schematically communication through the Internet 14 from the LAN 26 to the customer's PC 12. This illustrates the sending of authorization information (authorization or rejection) of a payment request through the Internet to the customer, in accordance with one feature of the invention.

As it is stated above, the e-mail message can be in a text format or in HTML format to give enhanced graphic and display capabilities. In either format, the message uses the style, graphics, etc., compatible with the biller's usage on its website so that it looks like it came from the biller.

This has the further benefit of making it more likely that the customer receives at least one of the two notices, (one sent by the biller and one by the authorizing party) even if one is lost in transit, while also providing the customer with an easily printable record of the approval or rejection. This helps to minimize errors, and customer dissatisfaction and complaints.

Also, the e-mail message bypasses the web vault 18 and the server 20, thus avoiding adding traffic through the server 20.

### PAYMENT AUTHORIZATION METHOD

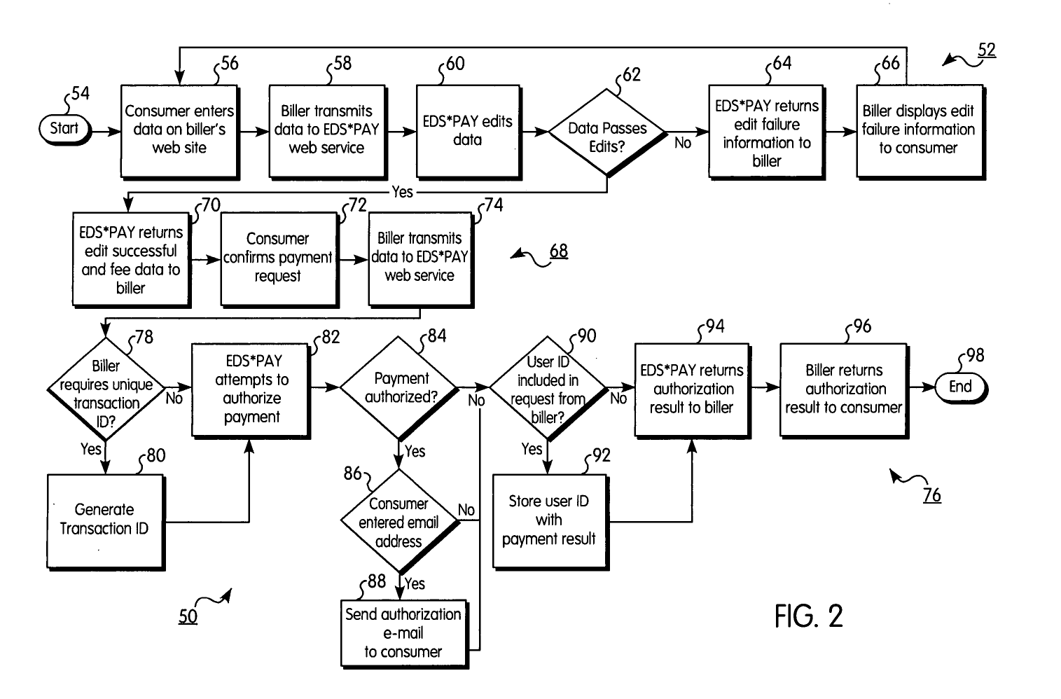

FIG. 2 is a flow chart 50 illustrating the method of the invention used in giving or denying authorization to a payment request. The first step in the method is an editing step indicated at 52 and starting at 54.

First, the consumer enters the data and sends it with a request for payment to the biller's website. The biller provides each customer with information regarding the data required to be submitted.

As indicated at 58, the biller then transmits the data to the payment authorizer (“EDS*PAY” in this case).

### EDITING DATA

Next, as indicated at 60, the payment authorizer edits the data.

First, the incoming data is checked to determine the presence of various parameters, some of which are required, in the specific embodiment being described. Other parameters are conditionally required, and still others are optional.

The required data includes an identification of the client or billing party, something to identify the consumer—e.g., the consumer's account number with the billing party, the payment account number—that is, the credit or debit card number or bank account number, the amount of payment, and the payment method.

In addition, a code is required to indicate which website of the billing party originated the request.

If a credit card or debit card is used, a code identifying the card being used is required as well as the expiration date for the card and the zip code or postal code of the credit or debit card billing address.

Conditional data for charges to a bank account includes the bank routing number and the customer name on the bank account.

Optional parameters include a date to process payment from a bank account, if payment is scheduled for a future date; a card verification code, for billers who use the card verification code as a further deterrent to fraud; a client user ID to identify payments entered by a specific service representative, in order to give credit to that representative for obtaining the payment, and the consumer's e-mail address for direct reporting by e-mail of acceptance or rejection of the payment request.

The results of the editing process are several different outputs of information. In general, the most significant information sent to the biller is whether the edit has failed and, if so, why. A similar message is to be sent to the customer or consumer, with a description of any errors that occurred. In addition, the amount of the fee to be paid by the biller is displayed, as well as the amount of the fee to be paid by the consumer.

Referring again to FIG. 2, the editing process used is shown at steps 64 and 66. If the information fails the editing process, at step 64, the authorizing party returns the edit failure information to the biller and at step 66 sends edit failure information to the consumer and returns to step 56, at which the data input is supplemented or corrected as necessary. The process is repeated until finally, at step 62 the data passes the edit.

Next, several steps 68 are instituted in order to initiate the actual authorization process. First, at step 70, the biller is informed that the edit has been successful and is given the fee information.

Next, at step 72, after the consumer has been advised that the edit is successful and as to the required charges, the consumer indicates to the biller that he wants the payment process to proceed, and, at step 74, the biller transmits an authorization request to the authorizing party.

### PAYMENT AUTHORIZATION

Referring again to FIG. 2, the payment authorization process is indicated generally at 76.

The first step is to determine whether the biller requires a unique identification for the transaction, as indicated at 78. If so, a transaction identification number is generated in step 80. A data base is maintained for each biller in which transaction identification numbers already used are listed, and the next available transaction number is selected for each new transaction. In addition, the newly selected identification number is stored in the data base.

After generation of the transaction identification number, or if there is no such identification, the authorization payment system attempts to authorize payment as indicated at 82.

The steps used by the authorizing party to obtain authorization depend upon whether payment is to be charged to a credit or debit card, or to a bank account.

If the payment is to be charged to a credit or debit card, the credit or debit card company is contacted with the credit card information and the amount of the proposed payment. The credit card company determines whether the credit card information is valid and, if a verification code is submitted, whether the verification code is correct for the other information supplied. If so, it determines whether the payment will increase the outstanding charges on a card beyond the charge limit for that card. If so, it rejects payment. If not, it approves payment and sends this information back to the authorizing party. This process is essentially the same for both debit and credit cards, except that the debit card limit is determined by the amount of money in the account, whereas the credit card limit is a credit limit set by the card company.

In the case of a charge to a bank account, when the authorization request is received, no attempt is made to determine whether or not the balance in the account is adequate to make the payment. Approval is given immediately, subject to later correction, as it will be explained below.

Authorization is attempted in step 82. The balance available to the card holder is decreased at this point in the process.

After step 82, at step 84 it is determined whether payment has been authorized or not.

If the answer is yes, at step 86 it is determined whether the consumer has entered its e-mail address. If so, at step 88, a direct authorization communication is sent through the Internet by e-mail to the consumer.

Whether the payment is authorized or not, at step 90 it is determined whether the user ID (the billing personnel identification) has been included in the request from the biller. If so, at step 92 the user ID is stored together with the payment result.

In either event, either when there is or there is not a user ID number, at step 94 the authorization result is transmitted to the biller, and, at step 96 the biller returns the authorization result to the consumer. The process ends at 98.

In the case of charges to a bank account, the authorization provider sends the amount of each charge through proper channels for clearance. Clearance normally takes a significant amount of time, e.g., several days. Typically, the clearance requests will be accumulated and sent out in a batch transmission at the end of each business day, or at varying time intervals so as to save expenses. Later, if the charge to the bank account fails to clear, the authorization provider will notify the biller who will then notify the consumer and will indicate that the bill has not been paid and still is owed.

It is within the scope of the invention to provide certification services, if desired. That is, if the biller needs an immediate guarantee of payment, such as when payment in advance is required before shipment of the goods, certification by the bank that the amount of the payment is available in the account, and a debit to the bank account can be provided by the bank. This information can be transmitted to the biller, and to the consumer as well.

In the case of credit or debit cards, the amount in question usually is debited against the account of the card holder immediately upon the request for authorization.

Normally, the biller and the consumer (if the consumer is directly notified) are given an authorization number for each authorized payment.

If the biller has selected the mode of operation where it wishes to receive a transaction identification code for every transaction and/or user ID number for each transaction, this information is listed in the authorization information returned to the biller.

All of the information developed for a given biller over a given period of time (usually one business day) is gathered into a report which is submitted to the client.

### PRE-AUTHORIZATION

An advantageous modification of the process is one in which a credit or debit card charge can be pre-authorized.

In this modification, the amount of a transaction is not needed. The cardholder information such as card number, expiration date, zip code, and verification code are validated, and notification is sent to the biller. This allows the biller to determine that the card is valid before proceeding with a transaction.

Later, if the biller and the consumer wish to proceed with a transaction, payment authorization can be requested and given as described above.

### REVERSING PAYMENT

In another modification, any payment authorized can be reversed via notification from the biller.

The biller informs the authorizing party of the authorization number given earlier, and the other information, such as credit card or bank information, and the authorizing party notifies the credit or debit card companies, if necessary, and sends notice to the biller that the authorization has been reversed and no charges have been made for the transaction.

### BILL PRESENTMENT UPDATE

In this modification, basic customer information is stored by the authorizing party for each customer for which the service is provided. The information includes the account number, amount due, due date, last payment and the date of the last payment, and is made available to the customer, through the biller's website.

Using web services, the biller can update this information at any time without sending a file to the authorizing party.

This improves customer confidence in the amount owed and minimizes errors, and is made easier by the use of web services.

A specific customer's account can be restricted by a biller to prevent the authorization of any payments by the customer, and the restriction can be removed.

This can be done very simply by the use of web services technology. The account number and the instruction can be sent as a function call so as to avoid sending a file.

### FEE CALCULATION

In some cases, the fee paid to the authorizing party depends on the amount being paid. Normally, the fee is not known until after the customer has had to enter a considerable amount of information, as indicated at step 70 in FIG. 2.

Instead, the fee can be calculated and disclosed to the customer (by the biller) after only the amount to be paid and the method of payment are input. This saves the customer substantial time and effort if he or she decides not to make that payment after the fee is known. The editing steps shown in FIG. 2 are modified as needed to accomplish the purpose.

### BATCH PAYMENTS

The system and method of the invention allow billers to send the authorizing party a file of payments to be made either immediately or at a specified later time.

Using web services, it is possible to send the payment instructions by means of a function call instead of by sending a file through use of the usual process. The usual process requires more operator attention and burden, and the use of web services streamlines and simplifies the process.

As it can be seen from the foregoing, the invention described above and set forth in the claims amply meets the objectives set forth above. The invention provides fast, reliable and easily printable notifications to the consumers of authorization or rejection of the payment requests, without undue increase in traffic in the authorization system. In addition, further protection against credit card fraud is provided, and optional unique transaction codes and user identification numbers are provided to the biller. Other problems mentioned above have been solved or significantly reduced.

The above description of the invention is intended to be illustrative and not limiting. Various changes or modifications in the embodiments described may occur to those skilled in the art. These can be made without departing from the spirit or scope of the invention.

1. A method of authorizing bill payments, said method comprising:
(a) receiving at an authorization website information sent by a biller through the worldwide web identifying the payor, and specifying the amount to be paid and the account to be used in making the payment;
(b) determining whether the payment should be authorized;
(c) transmitting through the worldwide web to a website of the biller authorization information authorizing the payment or refusing authorization;
(d) whereby authorization notification can be given to the payor from a website of the biller without disclosing that the authorization was obtained by anyone other than the biller, and
(e) sending an electronic notification to the payor that the payment has been authorized.

2. A method as in claim 1 including storing in connection with said authorization website format information for each of a plurality of billers, retrieving the format information for a given biller and formatting said electronic notification in the format of the biller to whom authorization is sent.

3. A method as in claim 1 in which the information received at said authorization website includes an e-mail address for the payor, and said notification sending step comprises sending said notification in the form of an e-mail sent directly to the payor through the worldwide web.

4. A method as in claim 1 in which said determining step comprises a step selected from the group consisting of determining whether the payment will exceed the credit limit of the payor's credit or debit card, and validating the payor's bank account.

5. A method as in claim 1 in which said determining step comprises, in a request for payment from a bank account, communicating authorization, later submitting the transaction for bank clearance, and communicating failure of clearance to said biller if and when received.

6. A method as in claim 5 in which said submitting step comprises accumulating a plurality of payment requests over a period of time, and submitting them for clearance in a batch after said period of time has elapsed.

7. A method as in claim 1 including the step of validating a credit or debit card to be used for payment and sending information of said validation to said biller prior to receipt of any request for authorization of a payment charged to said card.

8. A method as in claim 1 including the step of reversing said authorization at the request of the biller given prior to the end of the business day in which said authorization was given, and notifying any bank or credit card organization to whom the payment was communicated.

9. A method as in claim 1 including the step of storing at said authorization website basic billing information for each of a plurality of customers of a given biller, giving said biller access to the billing information for each of said customers to modify said information directly, and giving each customer access to such billing information for the customer's account.

10. A method as in claim 1 including said biller sending restrict/unrestrict instructions for the account of one or more customers, and storing said instructions in association with said authorization website, and retrieving and effectuating said instructions upon the receipt of a payment request for the account.

11. A method as in claim 1 including preliminarily providing a calculation of fees to the customer in response to supplying merely the amount and the means of payment.

12. A method as in claim 1 including said biller accumulating a plurality of payments to be authorized and sending them to said authorization website in a batch by means of a function call.

13. A method of authorizing bill payments, said method comprising:
(a) receiving at an authorization website information sent by a biller through the worldwide web identifying the payor, and specifying the amount to be paid and the account to be used in making the payment;
(b) determining whether the payment should be authorized;
(c) transmitting through the worldwide web to a website of the biller authorization information authorizing the payment or refusing authorization;
(d) whereby authorization notification can be given to the payor from a website of the biller without disclosing that the authorization was obtained by anyone other than the biller;
(e) said information received at said authorization website including a credit or debit card number and confirmation number for the card number;
(f) said determining step including determining whether said confirmation number is correct.

14. A method of authorizing bill payments, said method comprising:
(a) receiving at an authorization website information sent by a biller through the worldwide web identifying the payor, and specifying the amount to be paid and the account to be used in making the payment;
(b) determining whether the payment should be authorized;
(c) transmitting through the worldwide web to a website of the biller authorization information authorizing the payment or refusing authorization;
(d) whereby authorization notification can be given to the payor from a website of the biller without disclosing that the authorization was obtained by anyone other than the biller;
(e) said information received at said authorization website including a credit or debit card number and confirmation number for the card number;
(f) said determining step including determining whether said confirmation number is correct; and
(g) sending an electronic notification to the payor that the payment has been authorized.

15. A method of authorizing bill payments, said method comprising:
(a) receiving at an authorization website information sent by a biller through the worldwide web identifying the payor, and specifying the amount to be paid and the account to be used in making the payment;
(b) determining whether the payment should be authorized;
(c) transmitting through the worldwide web to a website of the biller authorization information authorizing the payment or refusing authorization;
(d) whereby authorization notification can be given to the payor from a website of the biller without disclosing that the authorization was obtained by anyone other than the biller;
(e) said information received at said authorization website including a credit or debit card number and confirmation number for the card number;
(f) said determining step including determining whether said confirmation number is correct;
(g) sending an electronic notification to the payor that the payment has been authorized; and
(h) storing in connection with said authorization website format information for each of a plurality of billers, retrieving the format information for a given biller and formatting said electronic notification in the format of the biller to whom authorization is sent.

16. A method of authorizing bill payments, said method comprising:
(a) receiving at an authorization website information sent by a biller through the worldwide web identifying the payor, and specifying the amount to be paid and the account to be used in making the payment;
(b) determining whether the payment should be authorized;
(c) transmitting through the worldwide web to a website of the biller authorization information authorizing the payment or refusing authorization;
(d) whereby authorization notification can be given to the payor from a website of the biller without disclosing that the authorization was obtained by anyone other than the biller, and
(e) assigning an identification number for each transaction for a given biller and transmitting said identification number to said biller.

17. A method as in claim 16 including storing all transaction identification numbers for each of a plurality of billers and transmitting said numbers to the appropriate biller in a report of transactions during a given period of time.

18. A method of authorizing bill payments, said method comprising:
(a) receiving at an authorization website information sent by a biller through the worldwide web identifying the payor, and specifying the amount to be paid and the account to be used in making the payment;
(b) determining whether the payment should be authorized;
(c) transmitting through the worldwide web to a website of the biller authorization information authorizing the payment or refusing authorization;
(d) whereby authorization notification can be given to the payor from a website of the biller without disclosing that the authorization was obtained by anyone other than the biller; and
(e) in which the information received at said authorization website includes information identifying the billing personnel responsible for the bill or bills being paid, including the step of storing and reporting said billing personnel to the biller when reporting the authoritarian results.

19. A method of authorizing bill payments, said method comprising:
(a) receiving at an authorization website information sent by a biller through the worldwide web identifying the payor, and specifying the amount to be paid and the account to be used in making the payment;
(b) determining whether the payment should be authorized;
(c) transmitting through the worldwide web to a website of the biller authorization information authorizing the payment or refusing authorization;
(d) whereby authorization notification can be given to the payor from a website of the biller without disclosing that the authorization was obtained by anyone other than the biller, and including one or more of the steps selected from the group consisting of:
(e) sending an electronic notification to the payor that the payment has been authorized;
(f) determining the correctness of the confirmation number of a credit or debit card used in the payment;
(g) assigning an identification number for each transaction for a given biller and transmitting said identification number to said biller;
(h) determining and reporting to the biller the identity of the billing personnel with the authorization result.

20. A system for authorizing bill payments, said system comprising:
(a) an authorization web server programmed for selective communication through the worldwide web with a plurality of billers' web servers;
(b) a programmed digital computer system linked to said authorization web server to obtain authorization information from financial institutions authorizing or rejecting payment requests received at said billers' web servers from payers' computers through the worldwide web and communicating authorization information to the appropriate billers' web servers by the use of web services programming;
(c) said programmed digital computer system being programmed to send directly to the payer's computer originating the payment request an e-mail containing said authorization information.

21. A system as in claim 20 in which said authorization information is sent to the payer's computer and the biller's web server substantially simultaneously.

22. A system as in claim 20 in which information regarding the format desired for communications to consumers on behalf of each of a plurality of billers is stored and retrieved to place the e-mail message sent to the payer in the format desired by this biller whose bill is being paid.

23. A system as in claim 20 in which said computer system is programmed to apply a transaction number to each transaction for a specific biller, store said transaction numbers, and report them to that biller.

24. A system in claim 20 in which said computer system is programmed to demand that credit/debit card confirmation numbers be submitted with any credit/debit card payment requests, and to use the confirmation number together with other credit card information to protect against fraud in obtaining authorization for credit/debit card payments.

25. A system as in claim 20 in which said computer system is programmed to receive, store, and report to each biller the identity of the billing personnel responsible for obtaining the payment authorized.
